(19) United States
(12) Patent Application Publication
(10) Pub. No.: US 2022/0258534 A1
(43) Pub. Date: Aug. 18, 2022

(54) VEHICLE WHEEL ASSEMBLY FOR ENHANCED ROAD GRIP

(71) Applicant: Jonathan KASPI, Haifa (IL)

(72) Inventor: Jonathan KASPI, Haifa (IL)

(21) Appl. No.: 17/176,741

(22) Filed: Feb. 16, 2021

(51) Int. Cl. B60C 7/00; B60B 21/12

(52) U.S. Cl. CPC B60C 7/00; B60B 21/12

(57) ABSTRACT

A vehicle wheel assembly includes a wheel, a tire, one or a plurality of protruding elements positioned fully or partially within the tire and a deployment mechanism configured to deploy said one or a plurality of protruding elements out of the tire to a deployed position utilizing pressure within the tire, and configured to retract said one or a plurality of protruding elements from the deployed position to a retracted position.

### FIELD OF THE INVENTION

The present invention relates to automobiles. More particularly, the present invention relates to a vehicle wheel assembly for enhanced road grip and propulsion with deployable protruding elements.

### BACKGROUND OF THE INVENTION

Tires are designed with distinctive qualities aimed at meeting various requirements for specific intended uses. Some tires are designed for consumer vehicles where the tire is likely to be driven on paved roads. As such, the tire is designed to give optimum driving performance on smooth surfaces like asphalt. Tires that are designed, for example, for asphalt roads have a moderately smooth surface, giving the tire a good grip of the smooth surface of a paved road, while facilitating economical fuel consumption and minimal tire wear. Some tires are designed to have deep grooves and crevices on their external surface for enhancing road grip of the tire when the road is wet.

Vehicles that are designated for mixed road or rough terrain driving may require tires that are designed for use on rough terrain. Off-road tires typically have a road-facing surface with deeper grooves and bigger protrusions than a tire designed for asphalt. The deep groves and big protrusions give the off-road tire a better grip of a rough terrain, such as dirt or gravel. Occasionally, drivers are faced with conditions and terrains, such as mud or sand, where even the off-road tires do not have the adequate structure that may be required for maneuvering over such challenging terrains and conditions. There are known solutions that offer an externally mountable accessory for enhancing grip, such as tire chains. These solutions might be uncomfortable or impractical in certain situations. For example, in order to place tire chains over the tires of a vehicle, the driver may have to exit the vehicle. Furthermore, it may be impossible to place tire chains over the tire if that tire has already dug into the mud. Additionally, if the tire chains remain on the tires, when these tires are driven over an asphalt road, the tire chains may be damaged and/or cause damage to the asphalt.

### SUMMARY OF THE INVENTION

There is provided, according to an embodiment of the invention, a vehicle wheel assembly comprising: a wheel; a tire; one or a plurality of protruding elements positioned fully or partially within the tire; and a deployment mechanism configured to deploy said one or a plurality of protruding elements out of the tire to a deployed position utilizing pressure within the tire, and configured to retract said one or a plurality of protruding elements from the deployed position to a retracted position.

In some embodiments of the invention, each of said one or a plurality of protruding elements is oriented substantially radially with respect to the wheel and is configured to deploy radially.

In some embodiments of the invention, each of said one or a plurality of protruding elements is oriented at a non-zero angle with respect to a radial axis of the wheel and is configured to deploy at said non-zero angle.

In some embodiments of the invention, the protruding element is configured to at least partially expand when deploying.

In some embodiments of the invention, a distal portion of the protruding element is larger than the rest of the protruding element.

In some embodiments of the invention, an opening on the tire through which a protruding element of said one or a plurality of protruding elements is configured to move is smaller than a distal portion of the protruding element, so as to prevent the distal portion of the protruding element from retracting into the tire.

In some embodiments of the invention, an opening is provided on the tire through which a protruding element of said one or a plurality of protruding elements is configured to move between the deployed position and the retracted position.

In some embodiments of the invention, when the tire is inflated, a protruding element of said one or a plurality of protruding elements expands to form a seal between the opening on the tire and that protruding element.

In some embodiments of the invention, the tire includes at least one elongated side wall surrounding the opening and extending into a space within the tire.

In some embodiments of the invention, at least one elongated side wall of that protruding element is configured to prolapse through the opening when in the deployed position.

In some embodiments of the invention, a protruding element of said one or a plurality of protruding elements is integral to the tire.

In some embodiments of the invention, a protruding element of said one or a plurality of protruding elements includes a flange at a proximal end of that protruding element to prevent that protruding element from detaching from the tire.

In some embodiments of the invention, a protruding element of said one or a plurality of protruding elements and a side wall of an opening, through which that protruding element is configured to move between the deployed position and the retracted position, define a latch.

In some embodiments of the invention, that protruding element and the side wall define opposing hooks.

In some embodiments of the invention, the tire and the protruding element are configured to have a low friction between them so as to facilitate the deployment and retraction of the protruding element.

In some embodiments of the invention, the tire comprises an opening through which the protruding element is configured to move between the deployed position and the retracted position, said opening comprises side walls, wherein an inner portion of the tire is made of the same material as the side walls of the opening, and wherein inner portion of the tire is integral to the side walls of the opening.

In some embodiments of the invention, the deployment mechanism is configured to be operated wirelessly.

In some embodiments of the invention, the protruding element includes an inflatable chamber.

In some embodiments of the invention, the deployment mechanism includes a motor.

In some embodiments of the invention, the deployment mechanism further includes one or a plurality of transmission elements.

In some embodiments of the invention, the deployment mechanism includes a ratcheting mechanism.

In some embodiments of the invention, the deployment mechanism includes an electricity generator that employs the motion of the wheel assembly to generate electricity.

### BRIEF DESCRIPTION OF THE DRAWINGS

In order for the present invention to be better understood and for its practical applications to be appreciated, the following Figures are provided and referenced hereafter. It should be noted that the Figures are given as examples only and in no way limit the scope of the invention. Like components are denoted by like reference numerals.

FIG. 1A shows a cross-sectional view of a vehicle wheel assembly for enhanced road grip, in accordance with some embodiments of the present invention, with a protruding element in a retracted position.

FIG. 1B shows a cross-sectional view of the vehicle wheel assembly for enhanced road grip shown in FIG. 1A, with a protruding element deployed.

FIG. 2A shows a cross-sectional view of a tire, in accordance with some embodiments of the present invention, with a protruding element retracted.

FIG. 2B shows a cross sectional view of the tire shown in FIG. 2A, in accordance with some embodiments of the present invention, with a protruding element deployed.

FIG. 2C shows a top isometric view of the tire shown in FIG. 2B with a protruding element deployed, in accordance with some embodiments of the present invention.

FIG. 3A shows a cross-sectional view of a tire with a protruding element, in accordance with some embodiments of the present invention, with a resilient holder, where the side walls along the tier opening are elongated.

FIG. 3B is an isometric view of the protruding element shown in FIG. 3A, in a deployed state.

FIG. 4A shows a cross-sectional view of a vehicle wheel assembly for enhanced road grip, in accordance with some embodiments of the present invention, with a tire having integral protruding elements, in a retracted position.

FIG. 4B shows a front sectional view of the vehicle wheel assembly for enhanced road grip shown in FIG. 4A with the integral protruding elements in a deployed position.

FIG. 5A shows a lateral cross-sectional view of a vehicle wheel assembly for enhanced road grip, in accordance with some embodiments of the present invention, with retracted protruding elements.

FIG. 5B shows a lateral cross-sectional view of the vehicle wheel assembly for enhanced road grip shown in FIG. 5A with the protruding elements in a deployed position.

FIG. 6A shows a wireless controller for controlling the position of the protruding elements in a vehicle wheel assembly, in accordance with some embodiments of the present invention.

FIG. 6B shows part of a remotely controlled deployment mechanism for deploying protruding elements of a vehicle wheel assembly, in accordance with some embodiments of the present invention.

FIG. 7A shows a cross-sectional view of a tire with an offset protruding element retracted, in accordance with some embodiments of the present invention.

FIG. 7B shows a cross-sectional view of the tire shown in FIG. 7A with the offset protruding element deployed.

FIG. 8A shows a cross-sectional view of another design for a vehicle wheel assembly for enhanced road grip, in accordance with some embodiments of the present invention, with protruding elements retracted.

FIG. 8B shows a cross-sectional view of the vehicle wheel assembly for enhanced road grip shown in FIG. 8A with protruding elements deployed.

FIG. 9A shows a cross-sectional view of a vehicle wheel assembly for enhanced road grip, in accordance with some embodiments of the present invention, with an inflatable protruding element in a retracted position.

FIG. 9B shows a cross-sectional view of the vehicle wheel assembly for enhanced road grip shown in FIG. 9A with the inflatable protruding element deployed.

FIG. 10A shows a cross-sectional view of a vehicle wheel assembly for enhanced road grip, in accordance with some embodiments of the present invention, with deployable protruding elements with controlled stoppers in a retracted position.

FIG. 10B shows a cross-sectional view of the vehicle wheel assembly for enhanced road grip shown in FIG. 10A with the protruding elements deployed.

FIG. 11A shows a cross-sectional view of a vehicle wheel assembly for enhanced road grip, in accordance with some embodiments of the present invention, with rachet regulated deployable protruding elements in a retracted position.

FIG. 11B shows a cross-sectional view of the vehicle wheel assembly for enhanced road grip shown in FIG. 11A with the protruding elements deployed.

FIG. 12A shows a cross-sectional view of an electromagnetic deployment mechanism with a ratchet for a vehicle wheel assembly for enhanced road grip, in accordance with some embodiments of the present invention, in a latched retracted position.

FIG. 12B shows a cross-sectional view of the electromagnetic deployment mechanism shown in FIG. 12A in an unlatched deployed state.

### DETAILED DESCRIPTION OF THE INVENTION

In the following detailed description, numerous specific details are set forth in order to provide a thorough understanding of the invention. However, it will be understood by those of ordinary skill in the art that the invention may be practiced without these specific details. In other instances, well-known methods, procedures, components, modules, units and/or circuits have not been described in detail so as not to obscure the invention.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium (e.g., a memory) that may store instructions to perform operations and/or processes. Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. Unless explicitly stated, the method embodiments described herein are not constrained to a particular order or sequence. Additionally, some of the described method embodiments or elements thereof can occur or be performed simultaneously, at the same point in time, or concurrently. Unless otherwise indicated, the conjunction “or” as used herein is to be understood as inclusive (any or all of the stated options).

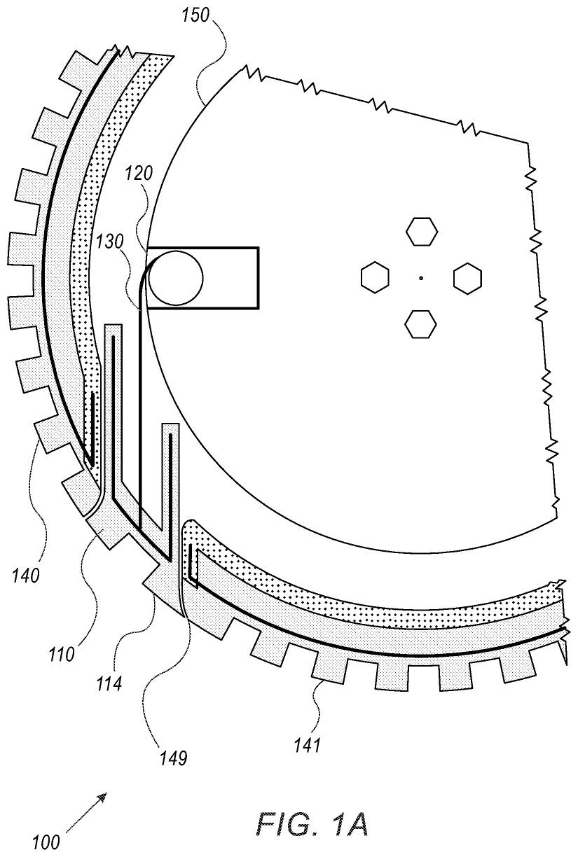

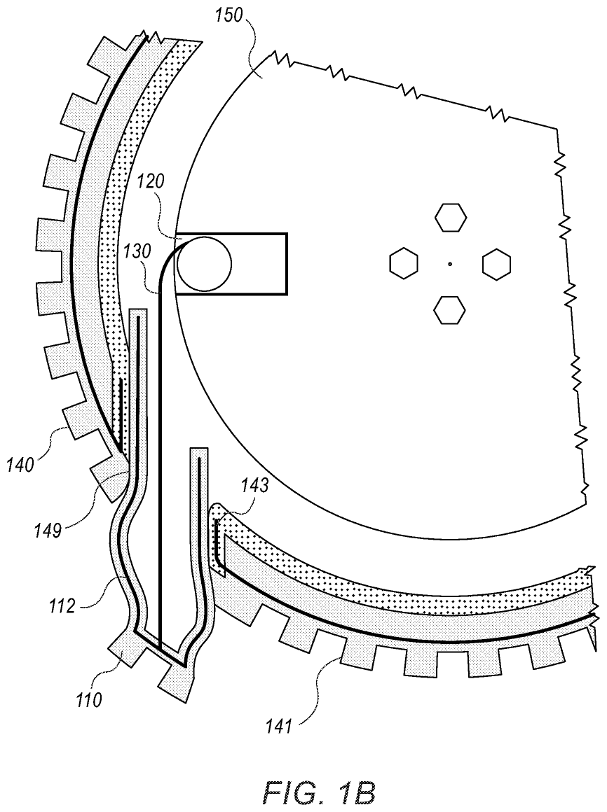

FIG. 1A shows a cross-sectional view of a vehicle wheel assembly for enhanced road grip, in accordance with some embodiments of the present invention, with a protruding element in a retracted position. Vehicle wheel assembly 100 may include tire 140 mounted inflated over wheel 150. Some embodiments of wheel 150 may be made of carbon fiber, rubber, metal or metal composite. Some embodiments of tire 140 may be made of materials such as rubber or a rubber and metal wire compound. Metal wires within the rubber increase structural integrity and strength of the tire.

Tire 140 may be inflated for proper operation. Tires may be inflated with air, a composition of gasses or even liquid. A composition of gasses may be used to inflate a racing tire due to the composition's higher stability in a fast-spinning tire. Liquid, such as water, may be used to fill the tire partially or completely for increasing the momentum, traction and stability of vehicles in agricultural or industrial applications. For sake of simplification, we will refer hereinafter to materials for inflating tube 140 as air, although other fluids are applicable too.

Tire 140 has external surface 141 and may have a pattern on external surface 141. Some tires, such as racing tires or motorcycle tires, may have a substantially smooth surface for enhancing grip on smooth roads. Some other tires, such as off-road tires or vehicle road tires, may have a pattern on the tire's external surface. Such pattern may allow water to be expelled from beneath the tire, preventing hydroplaning, that might otherwise cause the vehicle to skid on a wet road. Additionally, the groves may enhance grip of off-road tires. The pattern on the external surface of the tire may be a grid of longitudinal and latitudinal grooves or a distribution of protrusions along the surface of the tire.

Protruding element 110 may initially reside within tire 140, with an external surface 114 of protruding element 110 exposed through an opening 149 to fit with the rest of the external surface 141of tire 140. Protruding Element 110 may be hollow and may have sidewalls 112 that are flexible. Side walls 112 may inflate by the applied pressure from tier 140, causing side walls 112 of protruding element 110 to press against side walls 143 and opening 149 to form an airtight seal. For example, opening 149 may be provided on tire 140 through which a protruding element 110 of one or a plurality of protruding elements 110 may be configured to move between the deployed position and the retracted position.

Protruding element 110 may be positioned within tire 140 at a non-zero angle with regard to a radius of wheel assembly 100 (hereinafter: non radial deployment). For example, each of one or a plurality of protruding elements 110 may be oriented at a non-zero angle with respect to a radial axis of the wheel. Each one or a plurality of protruding elements 110 may be configured to deploy at a non-zero angle. For example, protruding element may be tilted or positioned at an angle so as to deploy and retract at said angle.

Protruding element 110 may be configured to deploy at an angle with respect to a radial direction of wheel assembly 100. For example if protruding element is deployed to the opposite direction of the direction of rotation of wheel assembly 100 with respect to the radial axes of wheel assembly 100, in some situation protruding element 110 may contribute more to the propulsion of the vehicle (e.g. have more grip, shovel more sand or gravel be better at digging out of sand), withstand heavier loads, or have more structural strength than if protruding element 110 were deployed along the rotation direction of wheel assembly 100.

In some other embodiments of the invention, the protruding element may be positioned radially with regard to a radius of wheel assembly 100 so as to deploy and retract radially with regard to a radius of wheel assembly 100. Such deployment may enable the highest use of the surface area of protruding element 110, and result efficient grip and propulsion. For example, each of one or a plurality of protruding elements 110 may be positioned radially with regard to a radius of wheel assembly 100. Each one or a plurality of protruding elements 110 may be configured to deploy and retract radially with regard to a radius of wheel assembly 100. For example, protruding element may be positioned at 0 angle with regard to the radius of wheel 100 so as to deploy and retract at said angle.

Protruding element 110 may be positioned within tire 140 with its external surface 114 exposed through opening 149, e.g., flush with the remainder of the external surface 141 of the tire 140. The external surface of protruding element 110 may include a pattern that matches a pattern of external surface 141 of the tire. In a retracted position, external surface 114 of protruding element 110 may be positioned flush with an external surface 141 of the tire 140 that is configured to contact the road. In some embodiments, the term “retracted position” may refer to the position of protruding element 110 when it is retracted within tire 140, i.e., not deployed or not substantially extending from external surface 141 of tire 140. For example, protruding element 110 in FIG. 1A is shown to be in a retracted position.

Tire 140 may include one or a plurality of protruding elements 110. For example, tire 140 may include one protruding element or many protruding elements. Protruding element 110 may be positioned fully or partially within tire 140. For example, protruding element 110 may be flush with surface 141 of tire 140, protruding element 110 may be positioned fully within tire 140 wherein protruding element 110 may be positioned within opening 149, or protruding element 110 may extend further from surface 141 of tire 140.

Deployment mechanism 120 may be configured to facilitate the deployment and retraction of protruding element 110. Deployment mechanism 120 of protruding element 110 may be configured to change the position of protruding element 110 from a retracted position to a deployed position, and vice versa. Deployment mechanism 120 of protruding element 110 may be configured to change the position of protruding element 110 from a retracted position to a range of deployment positions settings (continuous or discrete) wherein protruding element 110 may protrude at varying lengths from tire 140. Deployment mechanism 120 may be fastened or anchored to wheel 150. For example, deployment mechanism 120 may be positioned at an indentation in wheel 150, or deployment mechanism 150 may be fastened by a belt or a fastener to wheel 150. Deployment mechanism 120 may be positioned in a space between tire 140 and wheel 150. For example, deployment mechanism may be fastened by wire 130 to wheel 150 and to tire 140 or to protruding element 110. Wheel assembly 100 may include a valve for inflating tire 140. For example, the valve may be positioned on wheel 150 for ease of access, and pressurized air is pumped through the valve into tire 140. The pressure inside tire 140 may help in inflating tire 140 and assist in applying pressure on protruding element 110, thereby facilitating its deployment. Wheel assembly 100 may comprise other elements that are found generally in wheel assemblies (e.g., breaks, sensors, balance elements, etc.). Deployment mechanism 120 may include motor, actuator, drivers, pullies, bearings, controllers, wire cables, intersections, transceivers, transmission elements and the like for facilitating the deployment and retraction of protruding element 110. For example, deployment mechanism 120 may include a winch.

Deployment mechanism 120 may employ a wire 130. Wire 130 may be a fastener, rope, chain, wire or cord and any means fit for fastening, hereinafter generally referred to as wire. Deployment mechanism 120 or wire 130 may also include mechanisms that apply force, such as magnets or electromagnets for applying force, on protruding element 110. Deployment mechanism 120 may include one or more wires 130 connecting one or a plurality of protruding elements 110 to deployment mechanism 120. Protruding element 110 may be linked to deployment mechanism 120 with wire 130, e.g., deployment mechanism 120 may hold protruding element 110 in place using wire 130 that acts against the internal pressure of the tire 140. Wire 130 may be wound around a rotatable drum, configured to offer a substantial length to facilitate the deployment of protruding element 110 from the retracted position to the deployed position and hold the protruding element in the deployed position, preventing complete detachment from the wheel assembly.

Deployment mechanism 120 may be configured to deploy one or a plurality of protruding elements 110 out of tire 140 to a deployed position utilizing pressure within tire 140. For example, deployment mechanism 120 may deploy one, some or all protruding elements 110, and additionally, the pressure within tire 140 may be utilized to deploy protruding element 110, pushing protruding element 110 further from external surface 141 of tire 140. Deployment mechanism 120 may be configured to retract one or a plurality of protruding elements 110 from the deployed position to a retracted position. For example, deployment mechanism 120 may retract one, some or all protruding elements 110.

FIG. 1B shows a cross-sectional view of the vehicle wheel assembly for enhanced road grip shown in FIG. 1A, with the protruding element deployed. Protruding element 110 may protrude from the external surface of the tire 140 and is maintained in a deployed position as shown in FIG. 1B. The portion of side walls 112 of protruding element 110 that extend further from surface 141 of tire 140 may expand when protruding element 110 is in the deployed position due to the flexibility of the protruding element, which may be made, according to some embodiments, from the same material as the tire, with or without reinforcements (e.g., metal elements, such as wires or straps). The expanded portion of side walls 112 of protruding element 110 may engage in tight contact with opening 149 or with sidewalls 143 along opening 149 of tire 140, so as to prevent the escape of pressurized air from tire 140 and avoid unwanted deflation of tire 140. For example, protruding element 110 may be configured to at least partially expand when deploying to prevent air from escaping from tire 140. Additionally, the expanded portion of side walls 112 may increase the structural strength of protruding element 110 for withstanding the forces applied on protruding element 110.

Deployment mechanism 120 may facilitate the retraction of protruding element 110 from the deployed position to the retracted position by reeling in wire 130. When protruding element 110 is in the deployed position, protruding element 110 may momentarily be pressed back into the retracted position, when the wheel rotates to a position where the protruding element is substantially perpendicular to the surface of the road. When the entire wheel is positioned over the protruding element, protruding element 110 is pressed radially inward by the weight of the wheel and the vehicle into the retracted position. However, as wheel rotates further, the protruding element may again be pressured by the internal pressure within the tire and protrude back to the deployed position. When deployed in a sandy environment, protruding element 110 may act like a shovel for digging wheel assembly 100 out of the sand. For example, when protruding element 110 is retracted or when tire 140 has no protruding elements, tire 140 may dig into the sand and may spin in place without advancing the vehicle. However, when protruding element 110 is deployed, side walls 112 may dig into and push the sand like a shovel, advancing the vehicle forward (or backward). Side walls of tire 140 that surround the protruding elements 110, such as side walls 143, may surround protruding elements even in embodiments where there are no openings the tire. For example, when the protruding elements are an integral part of the tire. We may refer to the side walls of the tire that surround the protruding elements as “side walls within the tire” surrounding the protruding element or “side walls along opening of the tire” interchangeably, but these terms refer to the same element, which is walls that extend from the tire and surround the protruding elements.

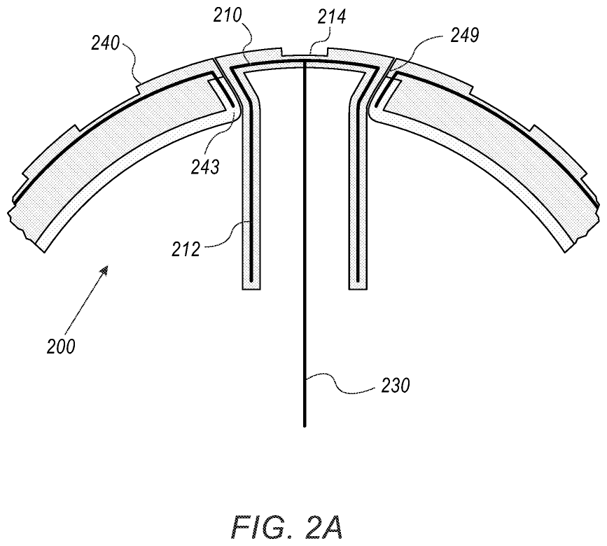

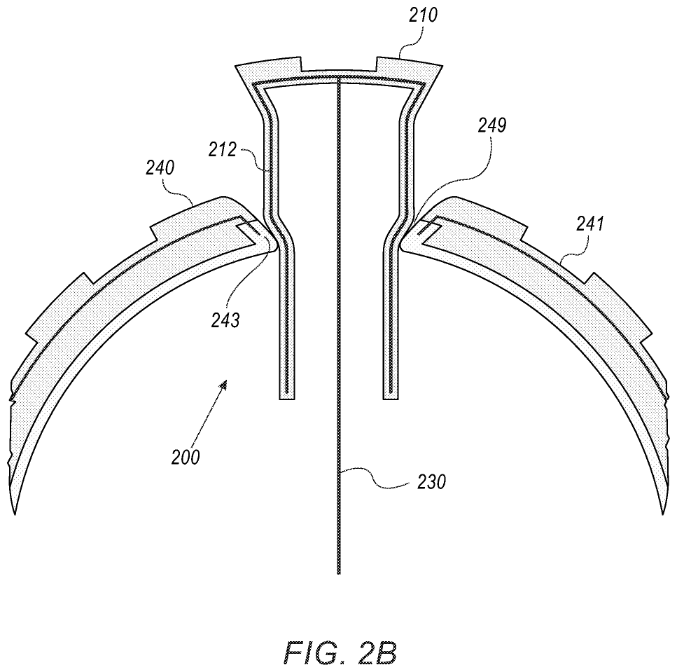

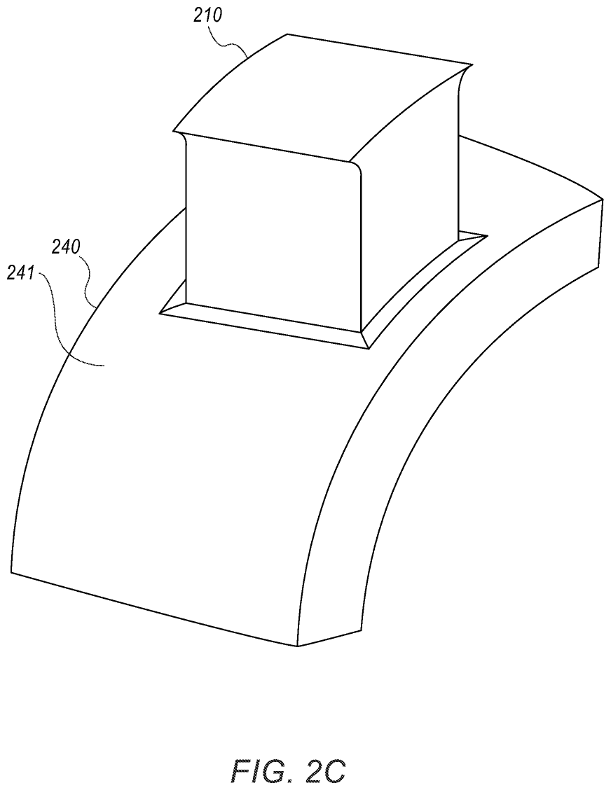

FIG. 2A shows a cross-sectional view of a tire, in accordance with some embodiments of the present invention, with a protruding element retracted. Protruding element 210 may be positioned in tire 240 within opening 249. Protruding element 210 may be oriented along a radial axis with respect to wheel assembly 200. Protruding element 210 may be configured to deploy in a radial direction.

Protruding element 210 may be outwardly flared or tapered at a distal portion near external surface 214. Side walls 243 of tire 240 may have an inclination that matches the tapering or flared part of protruding element 210. The tapered portion of protruding element 210 may prevent protruding element 210 from being fully plunged into tire 240, when an external force is applied on protruding element 210 inward toward wheel assembly 200, or when pulled inward, e.g., by a wire of the deployment mechanism. The flared portion of protruding element 210 may increase the grip of wheel assembly 200 on a road when protruding element 210 is deployed. The flared portion of protruding element 210 may act like a shovel for increasing the grip with the road. In this flared structure, the most distal portion of protruding element 210 may have a larger surface or cross-sectional area than the rest of protruding element 210. For example, protruding element 210 may have a tapered portion or a flared portion at its distal end that is larger than the rest of protruding element 210.

In some embodiments of the invention, tire 240 may have one or a plurality of openings 249, each opening 249 may be configured to reside protruding element 210. Protruding element 210 may be configured to move in opening 249 (e.g. move from a retracted position to a deployed position or any intermediate position between retracted and deployed positions). Protruding element 210 may have a distal end shaped differently than the rest of protruding element 210, so as to prevent protruding element 210 from retracting into tire 240. For example, distal end of protruding element 210 may be flared, have a flange, be wider or have a bigger diameter than rest of protruding element 210. Opening 249 on tire 240 may have at least one side wall 243 that matches the distal portion of protruding element 210, so as to prevent the distal portion of protruding element 210 from retracting into tire 240. For example, opening 249 or side wall 243 may be tapered or beveled near external surface 241, matching a flared distal end of protruding element 210, so that when protruding element 210 is retracted, flared distal end of protruding element 210 may prevent retracting protruding element 210 into tire 240. Opening 249 may be smaller than distal end of protruding element 210, so as to prevent the distal portion of protruding element 210 from retracting into tire 240.

FIG. 2B shows a front sectional view of the tire shown in FIG. 2A, in accordance with some embodiments of the present invention, with a protruding element deployed. Protruding element 210 may protrude further from external surface 241 of tire 240 when deploying. Protruding element 210 may be linked by wire 230 to a deployment mechanism within tire 240 (not shown in this figure). The portion of side walls 212 of protruding element 210 that further protrudes from external surface 241 of tire 240 may expand when protruding element 210 is in a deployed position. The expansion of side walls 212 of protruding element 210 may form a tight seal with opening 249 or with sidewalls 243 along opening 249 of tire 240, preventing escape of pressurized air from tire 240, and resisting the forces pushing protruding element 210 into tire 240, for keeping protruding element 210 deployed.

FIG. 2C shows a top isometric view of the tire shown in FIG. 2B with a protruding element deployed, in accordance with some embodiments of the present invention.

In some embodiments of the present invention, the internal portion of the tire and the side walls along the opening of the tire may be made from the same material, and said material may have a lower coefficient of friction than the coefficient of friction at the external surface of the tire. Making the internal portion and side walls from the same material may simplify the manufacturing and molding of the tire. Making the side walls 243 of the opening 249 from a material with a substantially lower coefficient of friction than the material of the external surface of the tire may ease the deployment of the protruding element from the retracted position to the deployed position. The side walls 243 of the opening 249 and/or the side walls of the protruding element may have a substantially lower coefficient of friction than the external surface of the tire. For example, the side walls 243 of the opening 249 and/or the side walls of the protruding element may have a smoother surface than the external surface of the tire. For example, they may undergo a treatment with a lubricant or they may undergo a smoothing treatment. For example, internal portion of tire 240 and side walls 243 of opening 249 may be made from the same material, said material may have a substantially lower coefficient of friction than the coefficient of friction of the material of the external surface 241 of tire 240 for facilitating the deployment of the protruding element.

In some embodiments of the present invention, an internal part of tire 240 may be made of a flexible and/or soft material that may have a low friction with its surroundings, said internal part of tire 240 may serve as a partition between the external material of tire 240 and protruding element 210, so as to facilitate smooth movement of protruding element 210 when protruding element 210 is in contact with side walls 243 along opening 249. For example, due to the elasticity or flexibility of the internal part of tire 240, said part may deform elastically under pressure (e.g., internal air pressure of tire) to form an air-tight seal with protruding element 210. Additionally, said internal part of tire 240 and side walls 243 may provide support for protruding element 210 for increasing the stability of protruding element 210 against external forces and for better sealing of the air inside tire 240.

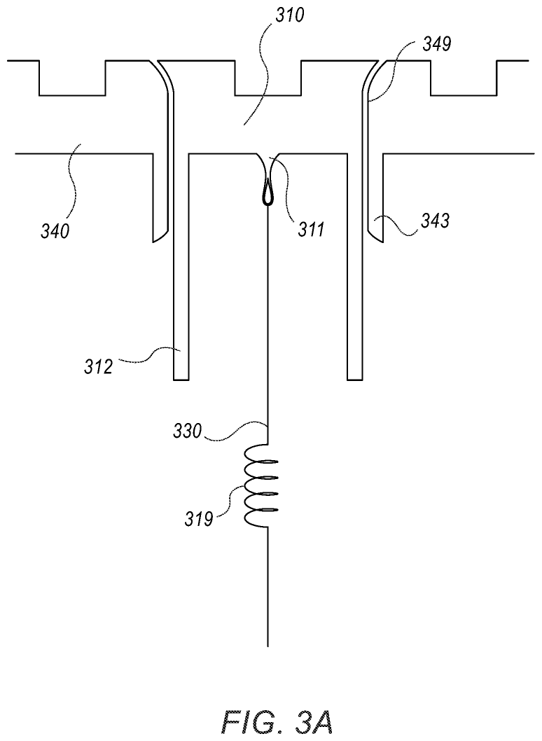

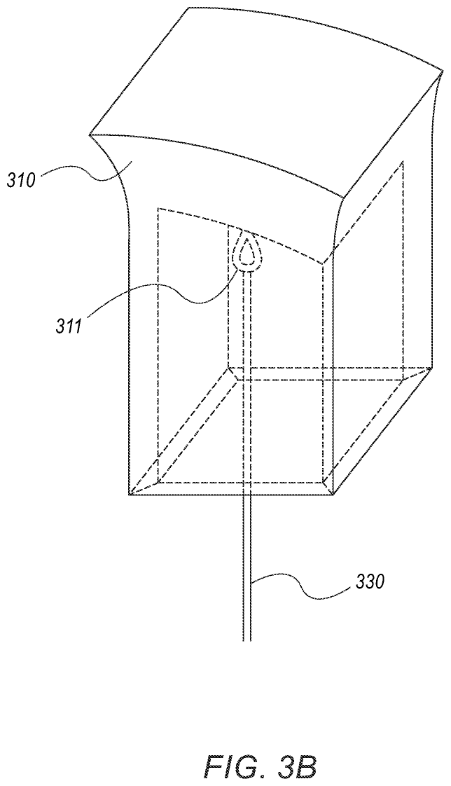

FIG. 3A shows a cross-sectional view of a tire with a protruding element, in accordance with some embodiments of the present invention, with a resilient holder, where the side walls along the tire opening are elongated. Tire 340 may have side walls 343 along opening 349. Side walls 343 may extend inwardly into a space contained between tire 340 and the wheel. For example, tire 340 may include at least one elongated side wall 343 surrounding opening 349 and extending into a space within tire 340. Side walls 343 may abut side walls 312 of protruding element 310. Side walls 343 along opening 349 may help prevent deflation of tire 340 that may be caused by the escape of pressurized air through opening 349. The increased contact surface area between protruding element 310 and tire 340 due to elongated side walls 343 may prevent air from escaping through opening 349.

Protruding element 310 may have reinforced portion 311 that connects to wire 330. Portion 311 of protruding element 310 may be reinforced, for example, by providing metal elements, e.g., metal wires, inside said portion, by increasing material density, by increasing the amount of material in that portion, or otherwise. Reinforced portion 311 of protruding element 310 may have a larger physical robustness in order to help it withstand the forces applied on it by wire 330 and the internal pressure of tire 340. Wire 330 may be connected to resilient holder 319. Resilient holder 319 may be a spring, a coil, an elastic rubber band or any similar element that applies force opposite to the direction from which it is pulled and has substantially elastic properties. Resilient holder 319 may be an integral part of wire 330. For example, wire 330 may comprise an elastic portion such as elastic rubber, or for example wire 330 may be fabricated in a method that increases its elasticity. Resilient holder 319 may provide a dynamic range of extension for wire 330. For example, if tire 340 were to deform or compress (for example if tire 340 rolled over a stone or an edge), the dynamic range of extension provided by resilient holder 319 may help to keep protruding element 310 in place and may help preventing inadvertent deflation of tire 340 due to the displacement of protruding element 310. Additionally, the dynamic range of extension of wire 330 may prevent tire 340 from deforming while retracting protruding element 310.

FIG. 3B is an isometric view of the protruding element shown in FIG. 3A, in a deployed state (dashed lines denote internal parts not shown from the outside). Reinforced portion 311 of protruding element 310 may include a ring or a hook for facilitating the coupling of protruding element 310 to wire 330. Reinforced portion 311 may be designed to be rigid (or relatively more rigid than the rest of the protruding element) and may be made, for example, of metal, rubber composite or strengthened rubber. Reinforcing portion 311 may be molded concurrently with protruding element 310 or added to protruding element 310 during an assembly process.

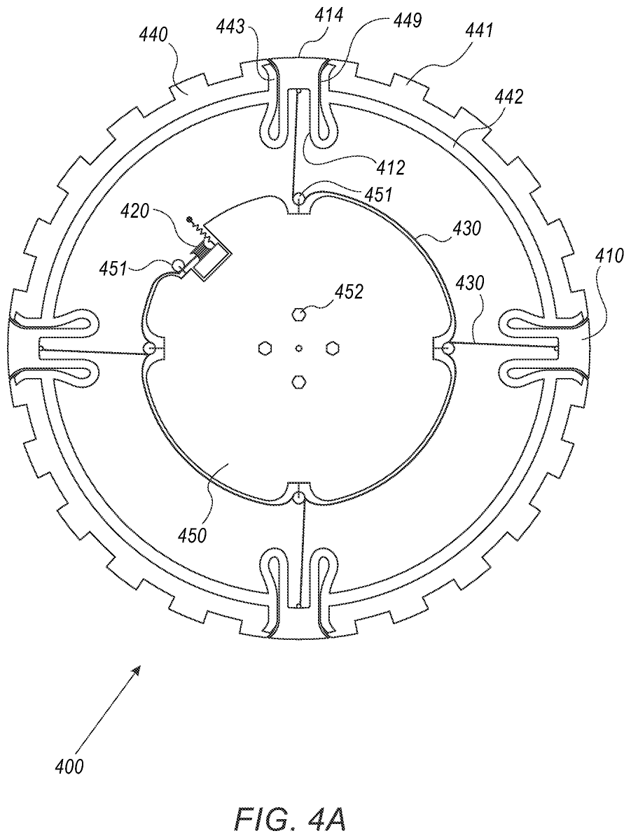

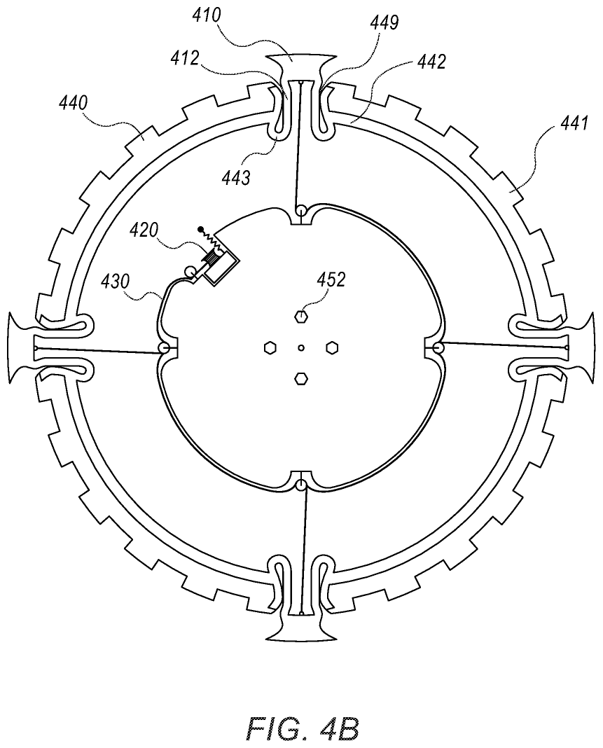

FIG. 4A shows a cross-sectional view of a vehicle wheel assembly for enhanced road grip, in accordance with some embodiments of the present invention, with a tire having integral protruding elements, in a retracted position. Wheel assembly 400 may have tire 440 mounted over wheel 450. Deployment mechanism 420 may be attached to wheel 450. Protruding element(s) 410 may be separately positioned in tire 440 in one of opening(s) 449. Protruding element 410 may initially be held at the retracted position as shown in FIG. 4A. External surface 414 of protruding element 410 may be positioned flush with external surface 441 of tire 440. Protruding element 410 may be fastened to deployment mechanism 420 via wire 430.

Tire 440 may have side walls 443 along opening 449. Side walls 443 may extend inwardly into the space confined between tire 440 and the wheel 450. Side walls 412 of protruding element 410 may be integrally linked to tire 440 at opening 449 (side walls 412 may be linked to an inner liner membrane or inner portion 442 of tire 440), and also form side walls 443 along opening 449 of tire 440, like an “inverted sock”. For example, protruding element 410 of one or a plurality of protruding elements 410 may be integral to tire 440. Internal layer 442 of the tire 440 may be integrally connected to protruding element 410. Protruding element 410 may be manufactured or molded together with internal layer 442 of tire 410 for simplifying the manufacturing process, or with the entire tire. In some embodiments, protruding element 410 may be fused or adhered to internal potion 442 of tire 410. As protruding element 410 is integrally connected to internal layer 442 of tire 410, pressurized air inside tire 410 cannot escape through opening 449. Additionally, protruding element 410 cannot be detached from tire 440 when protruding element 410 is deployed. Protruding elements 410 and the inner portion 442 of tire 440 may be made from a material sheet with a low coefficient of friction.

Deployment mechanism 420 may be coupled to and may operate one protruding element 410 or may operate a plurality of protruding elements 410, as shown in FIG. 4A, with wire 430. Wire 430 may be threaded though one or a plurality of bearings 451. Bearing 451 may comprise, for example, a pulley, wheel, ring or any other element for supporting wire movement about an angle or pivot with minimal friction. In certain embodiments, deployment mechanism 420 may deploy or retract all the protruding elements simultaneously, by releasing or retracting (respectively) wire 430.

FIG. 4B. shows a front sectional view of the vehicle wheel assembly for enhanced road grip with the integral protruding elements 410 shown in FIG. 4A in a deployed position. Protruding elements 410 are shown in their deployed positions.

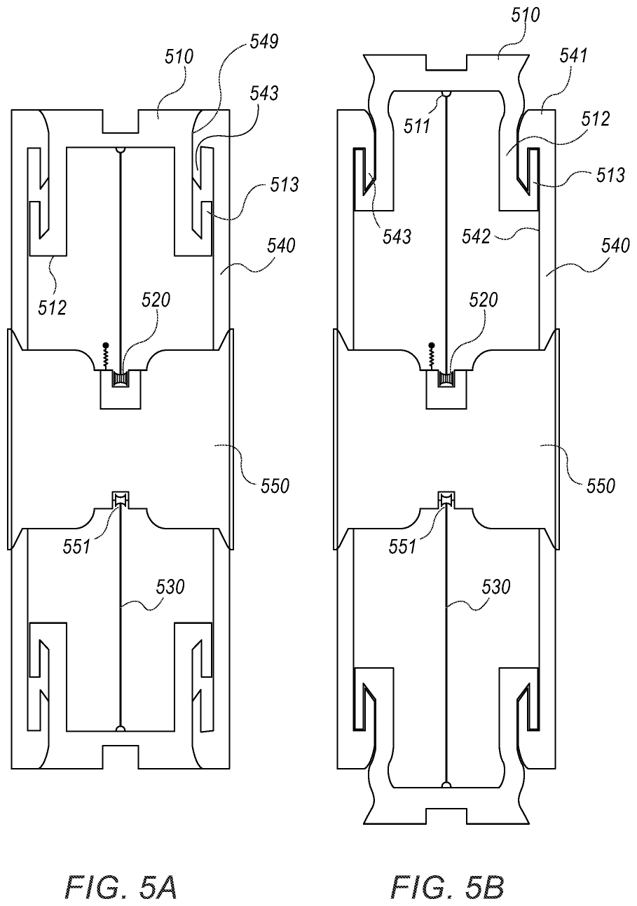

FIG. 5A shows a lateral cross-sectional view of a vehicle wheel assembly for enhanced road grip, in accordance with some embodiments of the present invention, with retracted protruding elements. Tire 540 may have side walls 543 along opening 549. Side walls 543 may extend inwardly into the space confined between tire 540 and the wheel 550. Side walls 543 may provide support against side walls 512 of protruding element 510. Side walls 512 of protruding element 510 may have bent stopper513 that may catch on side walls 543 along opening 549 of tire 540 for preventing the protruding element from being detached from the wheel assembly when protruding element 510 deployed. For example, protruding element 510 and side wall 543 may define opposing hooks or bent stoppers. bent stopper 513 may comprise hook, protrusion, latch, catch, bent stopper or other attachment to fasten around or hold to an object. Bent stopper 513 may extend from side walls 512. For example, side walls 512 may be manufactured or molded with a hook-like structure or bent stopper. Bent stopper 513 may be attached to side walls 512. For example, bent stopper513 or hook-like structure may be fastened or coupled to protruding element 510 during the assembly process. One or a plurality of side walls 512 of protruding element 510 may have one or a plurality of bent stoppers 513. For example, each protruding element may have one bent stopper or a plurality of bent stoppers.

Protruding element 510 may be connected to wire 530 that in turn may pass through a series of bearings 551 and connect to deployment mechanism 520 that may include an actuator or a motorized unit. Wire 530 may connect to one protruding element 510 or to multiple protruding elements 510. Wire 530 may facilitate the deployment and retraction of one or a plurality of protruding elements 510. Wheel 550 may have multiple deployment mechanisms connecting to one or a plurality of protruding elements with separate or connected wires 530.

FIG. 5B. shows a lateral cross-sectional view of the vehicle wheel assembly for enhanced road grip shown in FIG. 5A but with the protruding elements 510 in a deployed position. In a deployed position, protruding element 510 may extend further from external surface 541 of tire 540. Protruding element 510 may be fastened by wire 530. Deployment mechanism 520 may extend a length of cable 530 so as to deploy protruding element 510 by the same amount of length or until protruding element 510 is fully deployed. The end of the side walls 512 of protruding element 510 may include bent stopper513 for catching onto side walls 543 at opening 549 of tire 540. Bent stopper 513 of protruding element 510 may catch onto internal portion 542 of tire 540, a stopper or a catch-like structure in tire 540. When bent stopper 513 catches onto any catch-like structure of tire 540, bent stopper 513 prevents protruding element 510 from being detached from tire 540 when deploying.

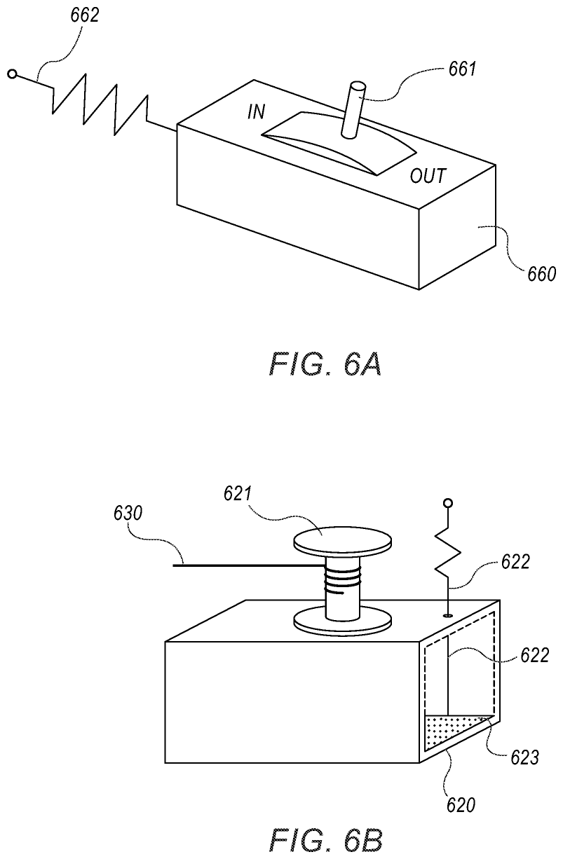

FIG. 6A shows a wireless controller for controlling the position of the protruding elements in a vehicle wheel assembly, in accordance with some embodiments of the present invention. Wireless controller 660 may be provided to communicate with the deployment mechanism, e.g., using antenna 662 and switch 661 for toggling between states. For example, toggling between the states of switch 661 may cause a deployment mechanism attached to one or a plurality of protruding elements inside the tire of a vehicle wheel assembly to deploy or retract said one or a plurality of protruding elements. Deployment mechanism 620 may be configured to be operated wirelessly. Wireless controller 660 may be controlled by the driver of the vehicle. Wireless controller 660 may be integrated or connected to the vehicle's control unit (e.g., the car's central controller), and, as such, wireless controller 660 may be automatically operated. For example, the vehicle may include an array of sensors and algorithms for automatically operating wireless controller 660 to deploy or retract the protruding elements.

FIG. 6B shows part of a remotely controlled deployment mechanism for deploying protruding elements of a vehicle wheel assembly, in accordance with some embodiments of the present invention. Deployment mechanism 620 may have antenna 622 and transceiver 623. Antenna 622 and transceiver 623 may receive wireless commands for operating the deployment mechanism wirelessly. For example, transceiver 623 may receive commands for controlling the rate or extent of deployment and retraction, or commands for stopping and commencing the deployment and retraction. Deployment mechanism 620 may include a motor and a rolling drum, wireless commands from transceiver 632 may control the movement of the motor and rolling drum for extending and retracting wire 630.

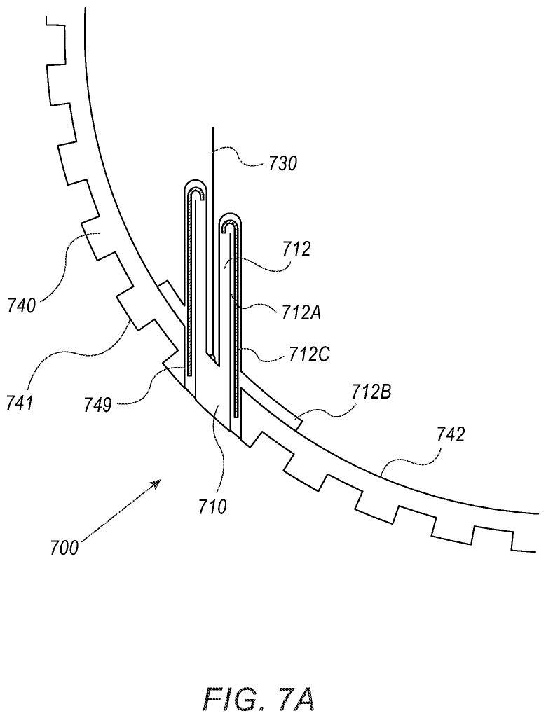

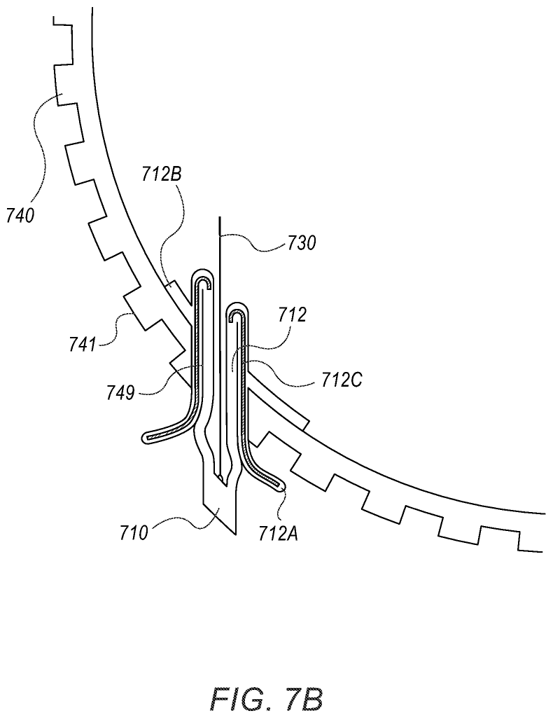

FIG. 7A shows a cross-sectional view of a tire with an offset protruding element retracted, in accordance with some embodiments of the present invention. Tire 740 may have side walls 743 along opening 749. Protruding element 710 may have side walls 712 that extend inwardly into a space confined between tire 740 and the wheel. Side walls 712 may be folded inside tire 740. For example side walls 712 may be bent or folded inside tire 740 when protruding element 710 is retracted, and side walls 712 may unfold when protruding element 710 is deployed. Folded side walls 712A may extend perpendicularly or radially to lateral extension 712B. For example, protruding element 710 may include a flange at a proximal end of protruding element 710 to prevent protruding 710 element from being detached from tire 740. This flange may take the form of lateral extension 712B that may be adhered, connected, molded or fastened to internal portion 742 of tire 740. This flange may also take the form of lateral extension 712B that may prevent protruding element 710 from being detached from tire 740 when deployed. Side walls 712 of protruding element 710 and folded side walls 712A may comprise a hollow portion 712C. Hollow portion 712C may be coated by or may comprise lubricating material. Side walls 743 along opening 749 of tire 740 and side walls 712 of protruding element 710 may be coated by or may comprise lubricating material. The lubricating material may include, for example, grease, oil, carbon powder and any material used for minimizing friction. The lubricating material may be inserted, assembled, coated, applied on, volcanized, sprayed on, adhered, molded or manufactured together with protruding element 710 or tire 740. The lubricating material may assist in lowering the friction between the moving parts when deploying and retracting protruding element 710.

Protruding element 710 may be made of non- or low-coefficient of friction materials. The lubricating material, together with folded side walls 712A and hollow portion 712C, enable the deployment or offset deployment of protruding element 710 even if protruding element 710 is made of high friction coefficient material. When protruding element 710 is deployed, hollow portion 712C enables the sides of folded side wall 712A to slide on each other for extending protruding element 710 outwards from tire 740. The friction between the moving elements during the retraction and deployment is low due to the lubricating material or low coefficient of friction between the inner sides of hollow portion 712C, and this in turn enables the deployment and retraction of protruding element 710 even if protruding element 710 is made of high friction coefficient materials.

FIG. 7B shows a cross-sectional view of the tire shown in FIG. 7A with the offset protruding element deployed. Protruding element 710 is in the deployed position as shown in FIG. 7B. Protruding element 710 may extend further from external surface 741 of tire 740. Protruding element 710 may be fastened by wire 730. When protruding element 710 is deployed, protruding element 710 may cause at least parts of side walls 712 and folded side walls 712A to deploy further from external surface 741 of tire 740. For example, at least one elongated side wall 712A of protruding element 710 may be configured to prolapse through opening 749 when in the deployed position.

The sides of folded side wall 712A may slide against each other and extend at least parts of folded side walls 712A to deploy. The deployed folded side walls 712A may facilitate the deployment of protruding element 710, and may increase the grip of wheel assembly 700. For example, when in a sandy environment, folded side walls 712A may act like an additional grip element when deployed to assist in propelling the vehicle. When protruding element 710 is retracted from the deployed position, folded side walls 712A are re retracted as well.

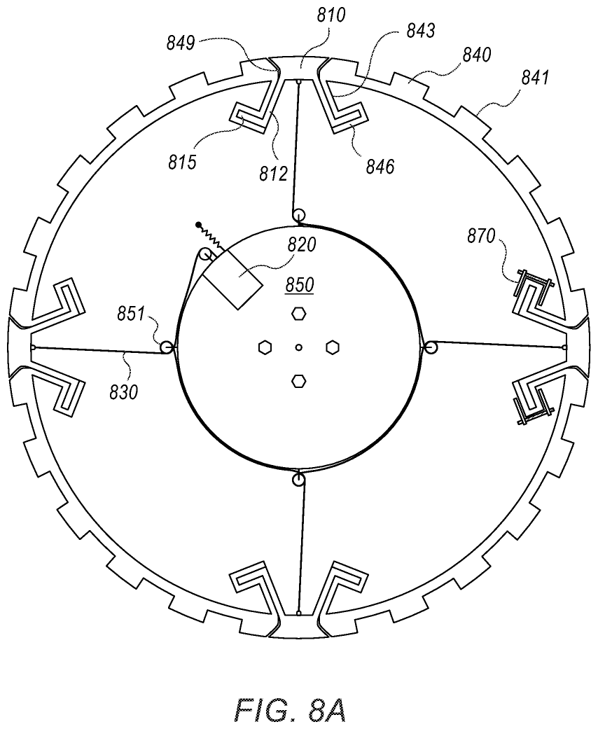

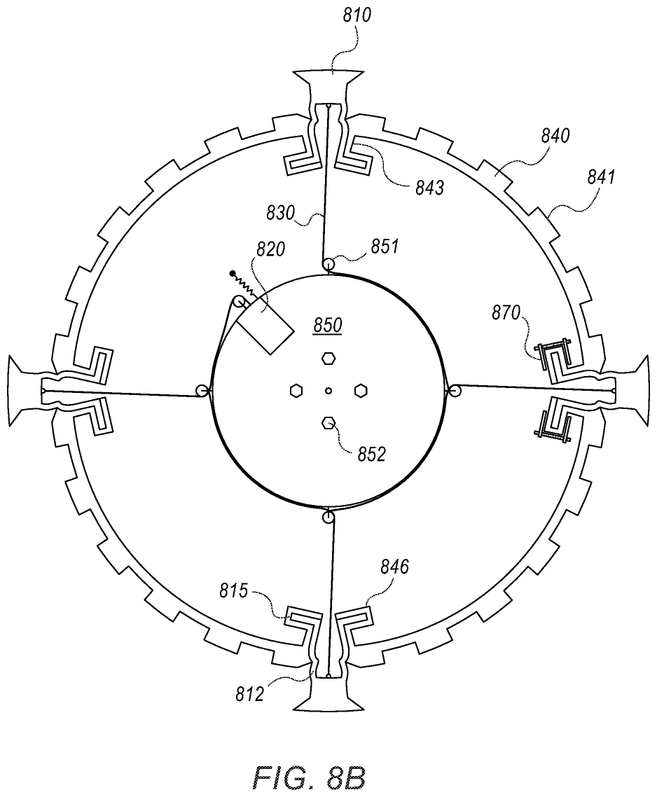

FIG. 8A shows a cross-sectional view of another design for a vehicle wheel assembly for enhanced road grip, in accordance with some embodiments of the present invention, with protruding elements retracted. Tire 840 may have side walls 843 along opening 849. Side walls 843 may extend inwardly into a space confined between tire 840 and wheel 850. Side walls 843 may abut, be clamped, be volcanized, adhere to, or connect to side walls 812 of protruding element 810. For example, side walls 843 may be molded, melted or glued together with protruding element 810, leading to a formation of an airtight seal between tire 840 and protruding element 810. Side walls 843 may be fastened to side walls 812 of protruding element 810 with fastener 870. Fastening or connecting side walls 843 to protruding element 810 may prevent protruding element 810 from being detached when protruding element 810 is deployed in the deployed position, or for example, it may help prevent escape of pressurized air through opening 849.

Side walls 812 of protruding element 810 may extend radially (or perpendicularly) with a side wall extension 815 with respect to protruding element 810 and fit in slot 846 that is formed on side walls 843 along opening 849 of tire 840 for increasing the contact between tire 840 and protruding element 810.

FIG. 8B shows a cross-sectional view of the vehicle wheel assembly for enhanced road grip shown in FIG. 8A with protruding elements deployed. Protruding element 810 is in the deployed position as shown in FIG. 8B. Protruding element 810 may extend further from external surface 841 of tire 840. Protruding element 810 may be fastened by wire 830 to deployment mechanism 820. Deployment mechanism 820 may be connected to wheel 850. Tire 840 may be connected or fastened to protruding element 810 for preventing protruding element 810 from being detached when protruding element 810 is deployed. When protruding element 810 is deployed or retracted, the pulling force of protruding element 810 may cause sidewalls 812 and side walls 843 to bend, stretch, twist, deform elastically or move in correlation with the extent that protruding element 810 is extended. For example, when protruding element is retracted, side walls 812 are in a neutral position (e.g. not bent or twisted), and when protruding element is deployed, side walls 812 may bend inwardly as they are pulled by protruding element 810. Protruding element 810 may inflate when deployed, increasing the structural strength of protruding element 810 for resisting the forces pushing protruding element back into tire 840.

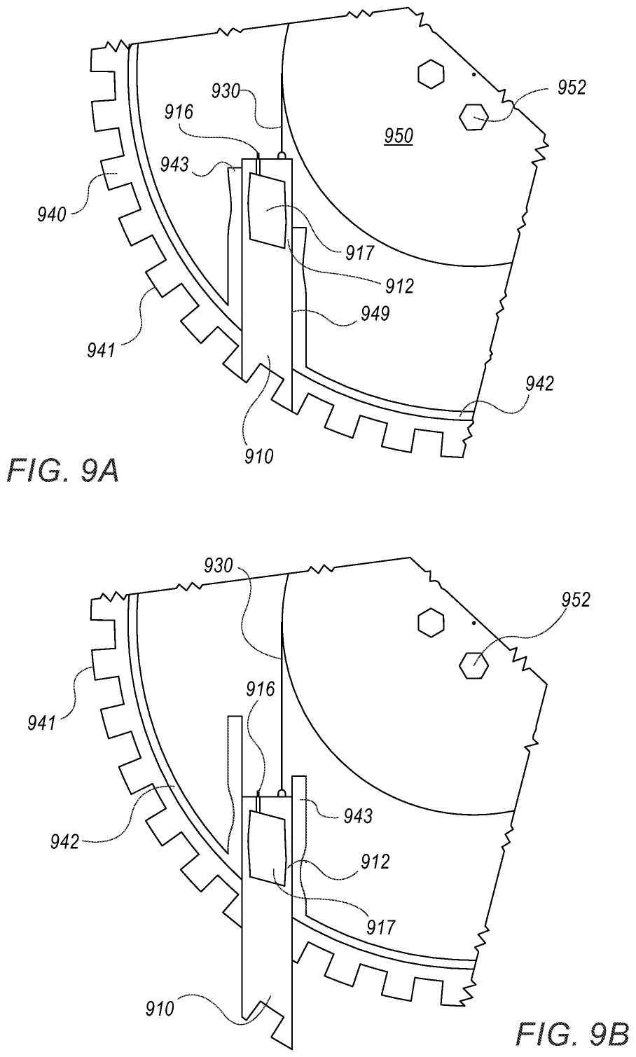

FIG. 9A shows a cross-sectional view of a vehicle wheel assembly for enhanced road grip, in accordance with some embodiments of the present invention, with an inflatable protruding element in a retracted position. Protruding element 910 may include valve 916 and inflatable chamber 917 that expands an internal part of protruding element 910. Inflatable chamber 917 may be inflated via valve 916. Inflatable chamber 917 may be inflated at varying pressures. For example, controlling the inflation of inflatable chamber 917 may lower or increase the friction between protruding element 910 and tire 940. The non-inflated segment of protruding element 910 may be more resistant to cuts, punctures, wear and deformation in comparison to the segment of protruding element that contains inflatable chamber 917. When an external force pushes protruding element 910 back towards tire 940, protruding element 910 may apply less pressure on side walls 943 because the non-inflatable segment of protruding element is less prone to stretching and deformation when under pressure of external forces, and this in turn may enable the choice of material with higher coefficient of friction for protruding element 910 (friction is less of an issue in retraction and deployment when protruding element does not deform when under external pressure). Inflatable chamber 917 may be attached or added to protruding element 910 rather than be an integral part of it. For example, inflatable chamber 917 may have different shapes and sizes, and inflatable chamber 917 may envelope part of protruding element 910.

FIG. 9B shows a cross-sectional view of the vehicle wheel assembly for enhanced road grip shown in FIG. 9A with the inflatable protruding element deployed. Protruding element 910 may further protrude from external surface 941 of tire 940. Protruding element 910 may be fastened by wire 930 to deployment mechanism 920. Deployment mechanism 920 may be coupled to wheel 950. Inflatable chamber 917 may be configured so as not to be able to deploy beyond external surface 941.

In some embodiments of the present invention, an internal part 942 of tire 940 may not be integral to tire 940. For example, internal part of tire 940 may be adhered or attached to tire 940, or it may be assembled with tire 940 to be detached at a later date for repair. Additionally, protruding element 910 may be integral to tire 940 or it may be separate.

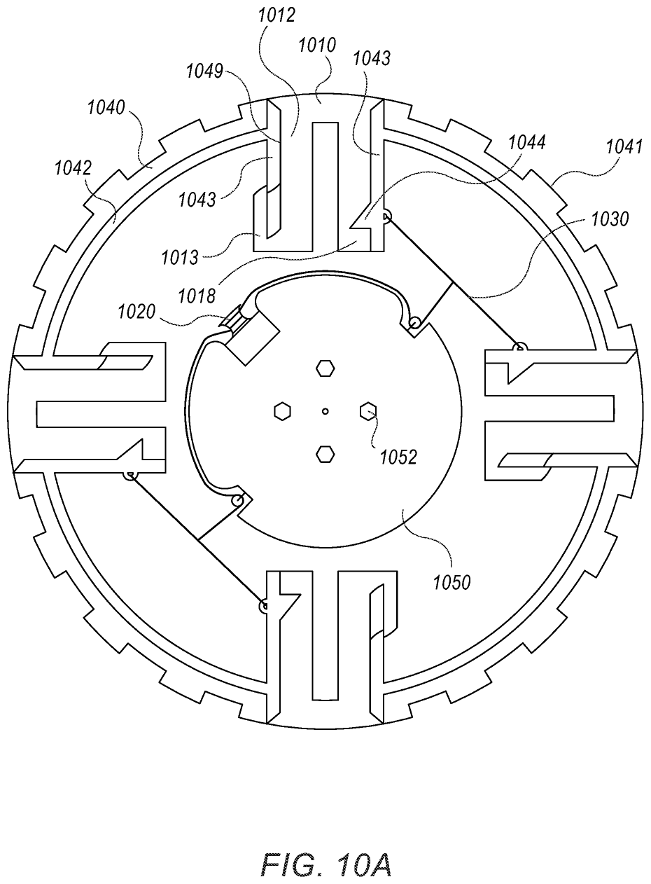

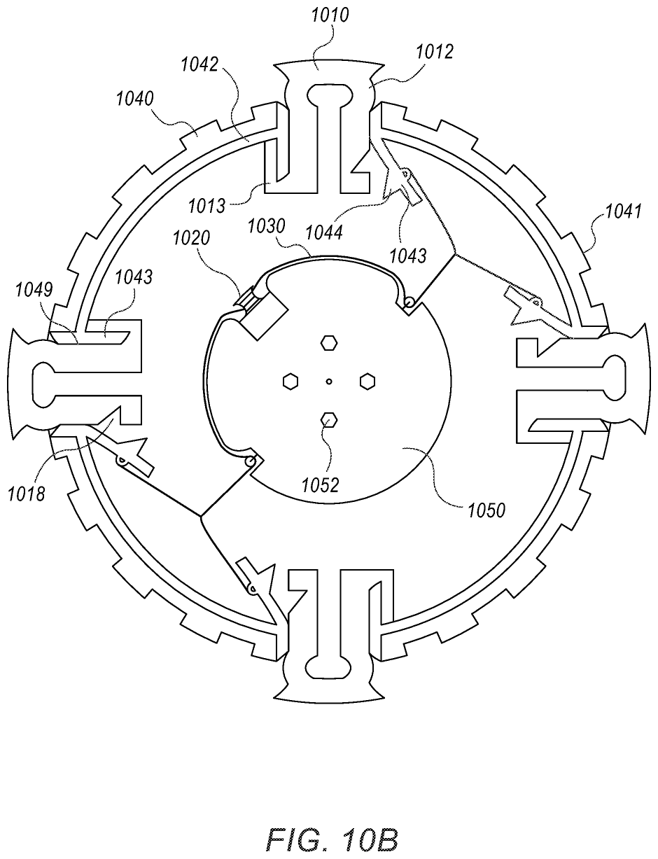

FIG. 10A shows a cross-sectional view of a vehicle wheel assembly for enhanced road grip, in accordance with some embodiments of the present invention, with deployable protruding elements with controlled stoppers in a retracted position.

Protruding element 1010 may be controlled indirectly by deployment mechanism 1020 so as to initialize the deployment or retraction of protruding element 1010. For example, protruding element 1010 may be pushed further from tire 1040 using internal pressure of tire 1040 when pin 1044 is moved directly by the control mechanism 1020(i.e., being deployed). Additionally, protruding element 1010 may be retracted to a retracted position using the external forces applied to protruding element 1010. For example, when protruding element 1010 is forced by the weight of the vehicle while protruding element is in contact with a surface abutting tire 1040, said force may push protruding element 1010 further into tire 1040 so as to facilitate the retraction of protruding element 1010.

Deployment mechanism 1020 may deploy protruding element 1010 without being fastened directly to protruding element 1010. For example, deployment mechanism may control a stopper or a latch that holds protruding element 1010 in the retracted position, and, when said stopper is released, the internal pressure of tire 1040 may push protruding element 1010 so as to deploy it. Tire 1040 may have side walls 1043 along opening 1049. Side walls 1043 may extend inwardly into a space contained between tire 1040 and wheel 1050. Side walls 1043 may abut side walls 1012 of protruding element 1010. Side walls 1012 of protruding element 1010 may have a bent stopper 1013. Bent stopper 1013 may catch on side walls 1043 along opening 1049 of tire 1040. Bent stopper 1013 may help prevent the protruding element 1010 from being detached from the wheel assembly when protruding element 1010 deployed in the deployed position. Side walls 1043 along opening 1049 of tire 1040 may have a protrusion or groove 1044 that latches to stoppers 1018, e.g., mating pairs of grooves and protrusions, on walls 1012 of protruding element 1010. For example, protruding element 1010 and side wall of opening 1043, through which protruding element 1010 is configured to move between the deployed position and the retracted position, may define a latch.

Deployment mechanism 1020 may be fastened with wire 1030 to side wall 1043 along opening 1049 of tire 1040 for latching or unlatching protrusion 1044 from stopper 1018. Stopper 1018 may latch (when in latching position) onto protrusion 1044 when protruding element 1010 is being retracted back from a deployed position, preventing an unintended redeployment of protruding element 1010 by the applied internal pressure from tire 1040. Side walls 1043 may have elastic properties, and side walls 1043 may deform elastically due to applied pressures (e.g., applied force by wire 1030). When the applied pressure on side walls 1043 subsides, side walls 1043 may return to their default positions for latching onto protruding element 1010.

Protruding element 1010 is in a retracted position as shown in FIG. 10A, wherein deployment mechanism extends wire 1030 so that protrusion 1044 is latched to stopper 1018 for keeping protruding element 1010 in first position. Side walls 1043 along opening 1049 of tire 1040 may have a low friction coefficient. Side walls 1043 may extend towards external surface 1041 for decreasing the friction applied on protruding element 1010. For example, when protruding element 1010 is deployed, protruding element 1010 may get inflated, such that the portion of side walls 1043 that extends outwardly (rather than the rough external surface 1041) may be in contact with inflated portion of deployable element 1010.

FIG. 10B shows a cross-sectional view of the vehicle wheel assembly for enhanced road grip shown in FIG. 10A with the protruding elements deployed. Protruding element 1010 is in the deployed position shown in FIG. 10B. Protruding element 1010 may extend further from external surface 1041 of tire 1040. Deployment mechanism may operate wire 1030 (e.g., may pull the wire) so that stopper 1018 is unlatched to allow deploying of protruding element 1010. For example, a relatively small force (in comparison to forces required for other methods of deployment) may be applied to lever side walls 1043 from the latched position. Bent stopper 1013 of protruding element 1010 may catch onto internal portion 1042 of tire 1040. Bent stopper 1013 of protruding element 1010 may catch onto side walls 1043 of tire 1040. When bent stopper 1013 catches onto any catch-like structure of tire 1040, bent stopper 1013 prevents protruding element 1010 from being detached from tire 1040 when protruding element 1010 is deployed. When pin 1044 is retracted, stopper 1018 is in the unlatched position and will not latch on side walls 1043. For example, if protruding element 1010 is pushed back into tire 1040 by external forces, protruding element 1010 will not be latched (pin 1044 is retracted), and protruding element 1010 may re-deploy due to internal pressure of tire 1040. Tire 1040 may roll on a soft or sandy surface, whereby deployed protruding elements 1010 may penetrate the soft surface and act like an additional gripping element to assist in propelling the vehicle.

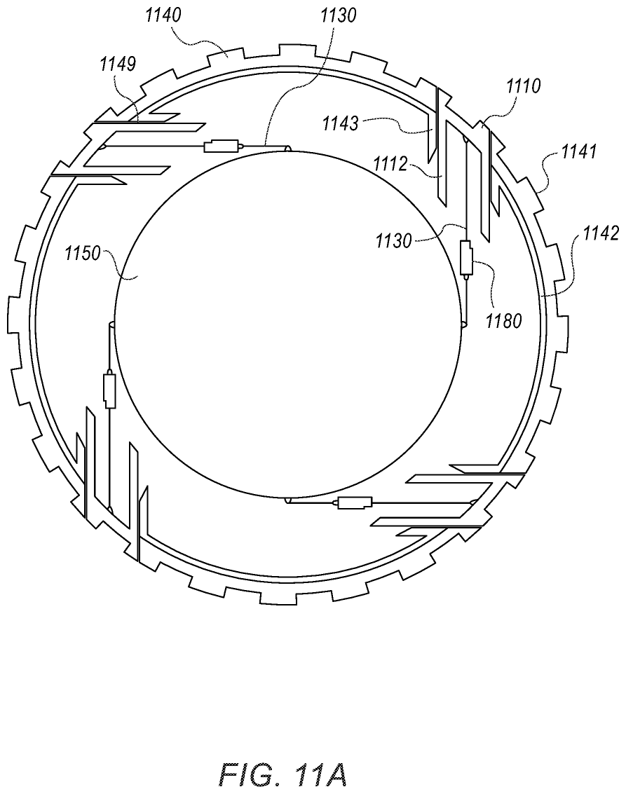

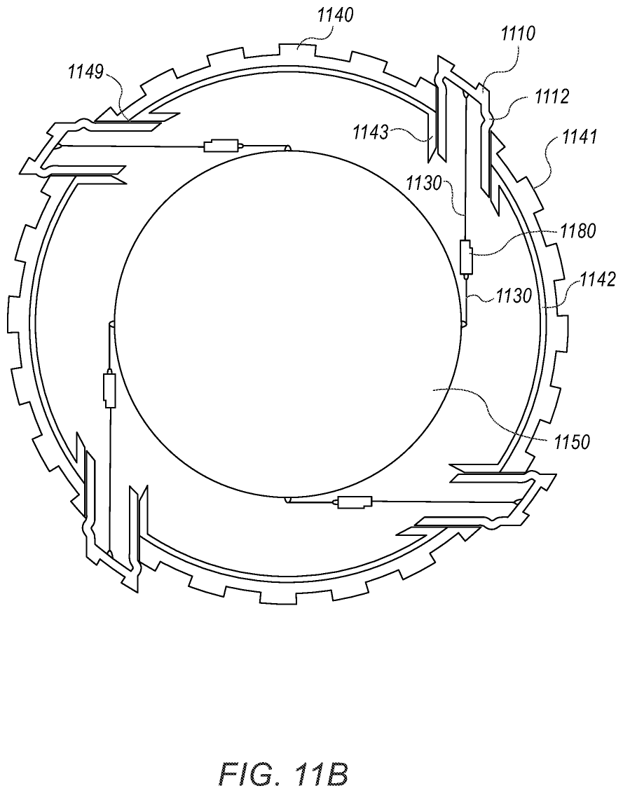

FIG. 11A shows a cross-sectional view of a vehicle wheel assembly for enhanced road grip, in accordance with some embodiments of the present invention, with rachet regulated deployable protruding elements in a retracted position. For example, the deployment mechanism of this vehicle wheel assembly may include ratcheting mechanism 1180. Ratcheting mechanism 1180 may facilitate the deployment and retraction of protruding element 1110 from tire 1140. Protruding element 1110 may be coupled through wire 1130 to ratcheting mechanism 1180. Ratcheting mechanism 1180 may hold protruding element 1110 in the retracted position. When the ratcheting mechanism 1180 is operated, ratcheting mechanism 1180 may unlatch, thereby deploying protruding element 1110. When the ratcheting mechanism 1180 is operated again, ratcheting mechanism 1180 may cause retraction of protruding element 1110 and latching thereof. Additionally, when ratcheting mechanism is operated again and protruding element 1110 is pushed into tire 1140 by external forces (e.g., the weight of the vehicle on the ground via protruding element 1110), ratcheting mechanism 1180 may prevent protruding element 1110 from re-deploying. Ratcheting element 1180 may include one or a plurality of latching positions, allowing protruding element to be deployed at varying lengths. Ratcheting mechanism 1180 may be connected to a power source or a controller (e.g., deployment mechanism control unit). Ratcheting mechanism 1180 may include an energy source such as a battery, and said energy source may be self-sustaining. For example, ratcheting mechanism may include a rechargeable battery with a recharging mechanism.

FIG. 11B shows a cross-sectional view of the vehicle wheel assembly for enhanced road grip shown in FIG. 11A with the protruding elements deployed. Protruding element 1110 may extend further from external surface 1141 of tire 1140.

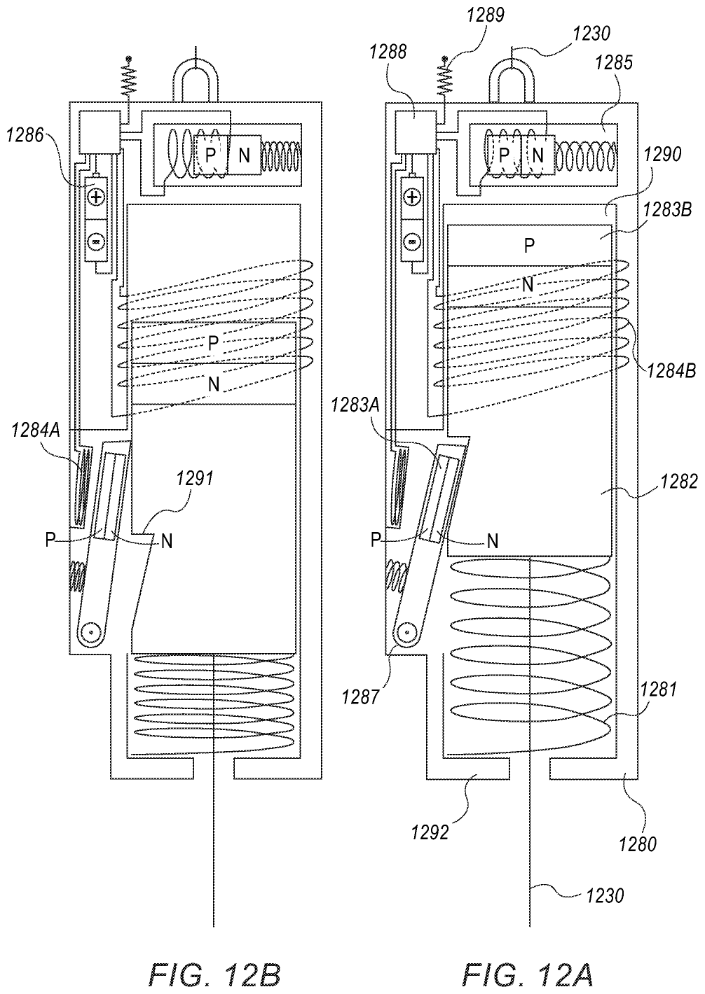

FIG. 12A shows a cross-sectional view of an electromagnetic deployment mechanism with a ratchet for a vehicle wheel assembly for enhanced road grip, in accordance with some embodiments of the present invention, in a latched retracted position. Ratcheting mechanism 1280 may have housing 1292 that connects to wire 1230. Housing 1292 may have chamber 1290 that contains a piston 1282. Piston 1282 may have a groove 1291 or multiple grooves. Ratcheting mechanism 1280 may hold piston 1282 in place by holding latch 1287 in groove 1291. When the protruding element is in the retracted position, ratcheting mechanism 1280 may be latched as shown in FIG. 12A. A deployment mechanism or ratcheting mechanism 1280 may include one or a plurality of electricity generators that utilize the movement of a vehicle wheel or of the protruding elements to generate electricity. For example, the deployment mechanism of a vehicle wheel assembly may comprise an electricity generator that employs the motion of the wheel assembly to generate electricity, as is known in the art. The generated electricity may be used for operating the deployment mechanism or ratcheting mechanism 1280. For example, the electricity generator may include magnet 1283B that moves within coil 1284B, generating a varying magnetic flux on coil 1284B. The varying magnetic flux is converted to electric current and stored in battery 1286 using controller 1288. In another embodiment, the deployment mechanism or ratcheting mechanism 1282 may have a vertical electricity generator for generating electricity from the radial movement of the vehicle wheel assembly or the protruding elements, or the deployment mechanism or ratcheting mechanism 1282 may have horizontal electricity generator 1285 for generating electricity from the movement of the vehicle wheel assembly. For example, a magnet attached to a spring can be used to harness the tire's pendulum-like movements.

Controller 1288 may connect to antenna 1289. Controller 1288 may receive wireless commands using antenna 1289. For example, controller 1288 may receive a wireless command to latch or to unlatch the ratcheting mechanism. Controller 1288 may control latch 1287 by engaging latch magnet 1283A using latch coil 1284A, causing latch 1287 to be withdrawn from groove 1291 for unlatching ratcheting mechanism 1280. Controller 1288 may control latch 1287 by disengaging latch magnet 1283 using latch coil 1284A, causing latch 1287 to be latched in groove 1291 for latching ratcheting mechanism 1280 as shown in FIG. 12.A.

FIG. 12B shows a cross-sectional view of the electromagnetic deployment mechanism shown in FIG. 12A in an unlatched deployed state. Controller 1288 may control latch 1287 by engaging latch magnet 1283 using latch coil 1284A, causing latch 1287 to be withdrawn from groove 1291 for unlatching ratcheting mechanism 1280 as shown in FIG. 12B.

Different embodiments are disclosed herein. Features of certain embodiments may be combined with features of other embodiments. Thus, certain embodiments may be combinations of features of multiple embodiments. The foregoing description of the embodiments of the invention has been presented for the purposes of illustration and description. It is not intended to be exhaustive or to limit the invention to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes as fall within the true spirit of the invention.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1. A vehicle wheel assembly comprising:
a wheel;
a tire;
one or a plurality of protruding elements positioned fully or partially within the tire; and
a deployment mechanism configured to deploy said one or a plurality of protruding elements out of the tire to a deployed position utilizing pressure within the tire, and configured to retract said one or a plurality of protruding elements from the deployed position to a retracted position.

2. The vehicle wheel assembly of claim 1, wherein each of said one or a plurality of protruding elements is oriented substantially radially with respect to the wheel and is configured to deploy radially.

3. The vehicle wheel assembly of claim 1, wherein each of said one or a plurality of protruding elements is oriented at a non-zero angle with respect to a radial axis of the wheel and is configured to deploy at said non-zero angle.

4. The vehicle wheel assembly of claim 1, wherein the protruding element is configured to at least partially expand when deploying.

5. The vehicle wheel assembly of claim 1, wherein a distal portion of the protruding element is larger than the rest of the protruding element.

6. The vehicle wheel assembly of claim 5, wherein an opening on the tire through which a protruding element of said one or a plurality of protruding elements is configured to move is smaller than the distal portion of the protruding element, so as to prevent the distal portion of protruding element from retracting into the tire.

7. The vehicle wheel assembly of claim 1, wherein an opening is provided on the tire through which a protruding element of said one or a plurality of protruding elements is configured to move between the deployed position and the retracted position.

8. The vehicle wheel assembly of claim 7, wherein, when the tire is inflated, a protruding element of said one or a plurality of protruding elements expands to form a seal between the opening on the tire and said protruding element.

9. The vehicle wheel assembly of claim 7, wherein the tire comprises at least one elongated side wall surrounding the opening and extending into a space within the tire.

10. The vehicle wheel assembly of claim 7, wherein at least one elongated side wall of said protruding element is configured to prolapse through the opening when in the deployed position.

11. The vehicle wheel assembly of claim 1, wherein a protruding element of said one or a plurality of protruding elements is integral to the tire.

12. The vehicle wheel assembly of claim 1, wherein a protruding element of said one or a plurality of protruding elements includes a flange at a proximal end of that protruding element to prevent that protruding element from detaching from the tire.

13. The vehicle wheel assembly of claim 1, wherein a protruding element of said one or a plurality of protruding elements and a side wall of an opening, through which that protruding element is configured to move between the deployed position and the retracted position, define a latch.

14. The vehicle wheel assembly of claim 13, wherein that protruding element and the side wall define opposing bent stoppers.

15. The vehicle assembly of claim 1 wherein the tire and the protruding element are configured to have a low friction therebetween, so as to ease the deployment and retraction of the protruding element.

16. The vehicle wheel assembly of claim 1, wherein the tire comprises an opening through which the protruding element is configured to move between the deployed position and the retracted position, wherein said opening comprises side walls, wherein an inner portion of the tire is made of the same material as the side walls of the opening, and wherein an inner portion of the tire is integral to the side walls of the opening.

17. The vehicle wheel assembly of claim 1, wherein the deployment mechanism is configured to be operated wirelessly.

18. The vehicle wheel assembly of claim 1, wherein the protruding element comprises an inflatable chamber.

19. The vehicle wheel assembly of claim 1, wherein the deployment mechanism comprises a motor.

20. The vehicle wheel assembly of claim 1, wherein the deployment mechanism further comprises one or a plurality of transmission elements.

21. The vehicle wheel assembly of claim 1, wherein the deployment mechanism comprises a ratcheting mechanism.

22. The vehicle wheel assembly of claim 1, wherein the deployment mechanism comprises an electricity generator that employs the motion of the wheel assembly to generate electricity.
